(19) United States
(12) Patent Application Publication
(10) Pub. No.: US 2010/0291827 A1
(43) Pub. Date: Nov. 18, 2010

(54) BASE INTERLINING AND COATED ROOFING MEMBRANES

(75) Inventor: Bertrand Weiter, Bobingen (DE)

Correspondence Address: JOHNS MANVILLE, 10100 WEST UTE AVENUE, PO BOX 625005, LITTLETON, CO, 80162-5005, US

(73) Assignee: JOHNS MANVILLE, Denver, CO (US)

(21) Appl. No.: 12/506,790

(22) Filed: Jul. 21, 2009

(30) Foreign Application Priority Data
Jul. 30, 2008 (DE) 20 2008 010 258.8

(51) Int. Cl. D04H 13/00; B32B 27/02; B32B 27/04

(52) U.S. Cl. 442/327; 428/221; 156/176

(57) ABSTRACT

The invention relates to a new base interlining for producing roofing membranes which have to meet a wide variety of requirements. The new base interlining provides a sufficient mechanical stability, good perforation strength, good tensile strength and a high resistance to thermal stress, inter alia required for base interlining during bituminization. In addition, the new base interlining requires a considerable reduced volume of impregnating bitumen when producing bituminized roofing materials and therefore high costs of special bitumens for filling the base interlining can be avoided. Beside the new base interlining, a method for producing it as well as roofing membranes comprising the base interlining are subject matter of this invention.

### BACKGROUND

The invention relates to a base interlining, a method for producing it as well as roofing membranes comprising a base interlining.

Base interlinings for producing roofing membranes have to meet a wide variety of requirements. In particular, base interlinings must have sufficient mechanical stability, such as good perforation strength and good tensile strength, which appear during further processing, for example, such as bituminization or laying. In addition, there is a need for high resistance to thermal stress, for example during bituminization, or to radiant heat and spreading fire. Many efforts have therefore been made to improve the existing base interlinings.

For instance, it is already known, to combine non-woven fabrics on the basis of synthetic non-wovens with reinforcing fibers, for example glass fibers, in order to improve their mechanical stability. Examples of such sealing membranes can be found in GB-A-1,517,595, DE-Gbm-77-39,489, EP-A-160,609, EP-A-176-847, EP-A-403,403 and EP-A-530,769. According to this state of the art, the fiber mat and reinforcing fibers are joined together by gluing by means of an adhesive agent or by needling the layers composed of different materials.

It is further known to produce composite materials by knitting or stitch bonding technologies. Examples thereof can be found in DE-A-3,347,280, U.S. Pat. No. 4,472,086, EP-A-333,602 and EP-A-395,548.

From DE-A-3,417,517 a textile interlining having anisotropic properties and a method for producing it is known. Said interlining consists of a substrate having a surface which melts below 150 DEG C and reinforcing filaments connected thereto which melt above 180° C. and are fixed to this surface in a parallel arrangement. According to one embodiment, said substrate may be a non-woven fabric on the one surface of which are arranged melt bonding fibers or melt bonding filaments that are provided to produce an adhesive bond between the parallel arranged reinforcing fibers and the non-woven fabric.

From U.S. Pat. No. 4,504,539 a combination of reinforcing fibers in the form of bicomponent fibers and non-woven fabrics on the basis of synthetic fibers is known.

From EP-A-0,281,643 a combination of reinforcing fibers in the form of a network of bicomponent fibers and non-woven fabrics on the basis of synthetic fibers is known, wherein the weight proportion of the network of bicomponent fibers is at least 15% by weight.

From JP-A-81-5879 a composite which is provided with a net-shaped reinforcing material is known.

From GB-A-2,017,180 a filter material composed of inorganic non-woven fabric and metal wires is known, which is used for the exhaust air purification at high temperatures (higher than 300 DEG C).

DE-Gbm-295 00 830 describes the reinforcement of a glass mat with synthetic monofilaments. These reinforcing monofilaments do not substantially contribute to the reference force at low elongation in the water-proof sheeting. They present, however, a sensibly higher elongation at maximum tensile force than the glass mat. Thus, the two-dimensional connection of the water-proof sheeting is ensured, even when it is subjected to deformations which may lead to the fracture of the glass mat. The shrinkage of the synthetic monofilaments is higher than the shrinkage of the glass mat and may result in waviness in the water-proof sheeting.

DE-A-3,941,189 likewise discloses a combination of reinforcing fibers in the form of a thread chain with non-woven fabrics on the basis of synthetic fibers which can be connected to each other in a great many ways. In this application, it is emphasized that the Young's modulus of the reinforced base interlining does not change compared with an unreinforced basic non-woven fabric.

From EP-A-0,806,509 and EP-A-0,806,510, there are known base interlinings comprising a textile fabric and a reinforcement which absorb the acting force already at a low elongation. Although such base interlinings have good application properties, the further improvement of these products is a permanent task.

Furthermore, it was known from the state of the art that the spunbonded non-wovens are subjected to a mechanical consolidation after their production. To this end, the spunbonded non-woven is usually subjected to a needling process. To reach a sufficient delamination stability, needle densities of 20 to 100 stitches/cm² are required. Even though needling is done by means of needles whose kick-up, preferably the sum of kick-up and barb depth, is smaller than the diameter of the reinforcing filaments, damages to the reinforcing filaments are unavoidable. Such damages may lead to problems with respect to the dimensional stability.

The base interlinings known from the state of the art are usually provided with a coating. To this end, the base interlinings are, depending on their intended use, passed through corresponding immersion baths, for example with bitumen, or provided with a coating product. By doing so, the open structure which constitutes a—more or less—large part of the void volume is filled. Due to the large air volume in the base interlining, a considerable volume of impregnating bitumen is required in order to completely replace the air by bitumen.

If the saturation by impregnating bitumen is insufficient, the properties which are important for subsequent use, such as delamination and moisture absorption, are considerably affected or not obtained at all.

Therefore, according to the state of the art, a complete preimpregnation of the base interlining is carried out in which the base interlining is passed through a preimpregnation bath, for example with highly viscous, generally unfilled bitumen, in order to eliminate the existing air in the base interlining.

The processing operations known in the state of the art which are used to obtain a finished roofing membrane are costly and complicated and require several process steps to achieve a sufficient saturation of the base interlining with the impregnating compound. Due to the high costs of special bitumens for filling the base interlining and the additional process steps which lead to a further considerable cost increase of the process, a new approach for the production of coated base interlinings is desirable.

Consequently, there is still a considerable need for products which properties of the finished base interlining are adversely affected or laying gets costlier.

Thus, it was the object of the present invention to provide improved base interlinings which can be cheaply produced in commercial quantities, and on the other hand can be provided with a coating in known but simplified processes.

### SUMMARY

Subject-matter of the present invention is thus a base interlining comprising a textile fabric with the following parameters:
a) the weight per unit area of the textile fabric is between 20 and 500 g/m²;
b) the air permeability of the textile fabric is between 250 and 1000 l/m² sec, measured according to EN-ISO 9237;
c) the thermal dimensional stability of the textile fabric is max. 0.9% in the longitudinal direction and max. 0.75% in the transverse direction, measured in conformity with DIN 18192;
d) the maximum tensile force lengthwise/crosswise is >500/>300 N/5 cm in conformity with DIN 29073, part 3;
e) the perforation resistance is >1200 N in conformity with DIN 54 307.

Furthermore, the base interlining of the invention may have reinforcements as well as additional textile fabrics, preferably textile fabrics which are different from the first textile fabric.

### BRIEF DESCRIPTION OF THE FIGURE

FIG. 1 represents the improvement of the thermal dimensional stability of the base interlining of the invention compared with base interlinings without the calendering process of the invention.

### DETAILED DESCRIPTION

### Reinforcement of the Base Interlining

In a preferred embodiment of the invention, the base interlining has at least one reinforcement. This reinforcement is designed so as to absorb a force so that in the force-elongation-diagram (at 20 DEG C), the reference force of the base interlining with reinforcement compared to the base interlining without reinforcement differs in the range between 0 and 1% elongation at least at one location by at least 10%.

In another embodiment, the reinforcement of the base interlining can be incorporated in such a way that, due to the reinforcement, forces are only absorbed at higher elongations.

The good mechanical properties of the base interlining of the invention are in particular achieved by reinforcement filaments and/or reinforcement yarns whose Young's modulus is at least 5 Gpa, preferably at least 10 Gpa, most preferably at least 20 Gpa. The reinforcement filaments mentioned above, that is, the monofilaments as well as the yarns, have a diameter of between 0.1 and 1 mm or 10-400 tex, preferably 0.1 and 0.5 mm, particularly 0.1 and 0.3 mm, and have an elongation at fracture of 0.5 to 100%, preferably 1 to 60%. It is particularly advantageous that the base interlinings of the invention have an elongation reserve of less than 1%.

Elongation reserve signifies the elongation which acts on the base interlining before the acting force is deviated to the reinforcing filaments, that is, an elongation reserve of 0% would mean that tensile forces acting on the base interlining would immediately be deviated to the reinforcing filaments. This means that forces acting on the non-woven fabric do not cause an alignment or orientation of the reinforcing filaments first but are directly deviated to the reinforcing filaments, so that damages of the textile fabric can be avoided. This is particularly evident in a sharp increase of the force to be applied at small elongations (force-extension diagram at room temperature). In addition, the maximum tensile force of the base interlining can be considerably increased by means of appropriate reinforcing filaments having a high elongation at fracture. Appropriate reinforcing filaments are, for example, monofilaments or multifilaments made from polyester.

Multifilaments and/or monofilaments on the basis of aramids, preferably so-called high-modulus aramid fibers, carbon, glass, glass rovings, mineral fibers (basalt), high strength polyester monofilaments or multifilaments, high strength polyamide monofilaments or multifilaments, as well as so-called hybrid multifilament yarns (yarns containing reinforcing fibers and lower melting binding fibers) or wires (monofilaments) composed of metals or metal alloys are preferably used as reinforcing filaments.

For economic reasons, preferred reinforcements consist of glass multifilaments in the form of essentially parallel yarn sheets or scrims. Mostly the reinforcement is done in the longitudinal direction of the non-woven fabrics by essentially parallel running yarn sheets.

The reinforcing filaments may be used as such or in the form of a discrete textile fabric, for example as a woven fabric, a scrim, a knitted fabric, a warp-knitted fabric or a non-woven fabric. Reinforcements with reinforcing yarns running parallel to each other, that is, warp sheets, as well as scrims or woven fabrics are preferred.

The yarn density can vary in wide limits depending on the desired properties profile. Preferably, the yarn density is between 20 and 250 yarns per meter. The yarn density is measured perpendicular to the grain of the yarn. The reinforcing filaments are preferably fed during the spunbonded non-woven is produced and thus embedded in the spunbonded non-woven. Also preferred is a deposition of the non-woven fabric on the reinforcement or a subsequent formation of layers of reinforcement and non-woven fabric by assembly beaming.

Preferred base interlinings of the invention have at least one reinforcement and show in the force-elongation diagram (at 20 DEG C) that the reference force of the base interlining with reinforcement compared to the base interlining without reinforcement differs in the range between 0 and 1% elongation at least at one location by at least 10%, preferably by at least 20%, most preferably by at least 30%.

For a number of applications, however, a high modulus at small elongations even at room temperature is desired. This high modulus improves handling, in particular in the case of lightweight non-woven fabrics.

The reference force of the reinforced base interlining at small elongations can be distributed in varying proportions on the textile fabric or the reinforcements, depending on the requirements profile and also depending on cost factors.

The measurement of the reference force is carried out in conformity with EN 29073, part 3, on 5 cm wide samples at a restraint length of 200 mm. Here, the numerical value of the pretension, given in centinewton, equals the numerical value of the area mass of the sample, given in gram per square meter.

The reinforcement of the base interlining can be carried out by installing the reinforcements in the textile fabric, on at least one side of the textile fabric or at any location of the base interlining, in particular in further textile fabrics which are different from the first textile fabric or as a discrete textile fabric.

### Textile Fabric

In the context of this description, the term “textile fabric” must be understood in its broadest sense. It can mean any structure composed of fibers which is made according to a technique for producing two-dimensional fabrics. The fiber-forming materials are natural fibers and/or fibers composed of synthesized polymers. Examples of such textile fabrics are woven fabrics, yarn sheets, knitted fabrics and preferably non-woven fabrics.

Among the non-woven fabrics composed of fibers, spunbonded non-wovens, also known as spunbonds, which are produced by random deposition of freshly melt-spun filaments, are preferred. They consist of continuous synthetic fibers composed of melt-spinnable polymer materials. Suitable polymer materials include, for example, polyamides, such as polyhexamethylenediadipamide, polycaprolactam, wholly or partly aromatic polyamides (“aramids”), aliphatic polyamides, such as nylon, partly or wholly aromatic polyesters, polyphenylene sulfide (PPS), polymers having ether and keto groups, such as polyetherketones (PEKs) and polyetheretherketone (PEEK), polyolefines, such as polyethylene or polypropylene, or polybenzimidazoles.

The spunbonded non-wovens preferably consist of melt-spinnable polyesters. The polyester material can, in principle, be any known type suitable for the fiber production. Such polyesters consist predominantly of components derived from aromatic dicarboxylic acids and from aliphatic diols. Commonly used aromatic dicarboxylic acid components are bivalent residues of benzenedicarboxylic acids, especially of terephthalic acid and of isophthalic acid; commonly used diols have 2 to 4 carbon atoms, wherein ethylene glycol is particularly suitable. Spunbonded non-wovens which consist of at least 85 mole % polyethylene terephthalate are particularly advantageous. The remaining 15 mole % are composed of dicarboxylic acid units and glycol units, which act as so-called modifying agents and which enable the person skilled in the art to influence the physical and chemical properties of the produced filaments in a targeted manner. Examples of such dicarboxylic acid units are the residues of isophthalic acid or of aliphatic dicarboxylic acid, such as glutaric acid, adipic acid, sebacic acid; examples of modifying diol residues are those of diols having longer chains, for example of propanediol or butanediol, of di- or triethylene glycol or, if present in a small amount, of polyglycol having a molecular weight of about 500 to 2000.

Particular preference is given to polyesters containing at least 95 mole % of polyethylene terephthalate (PET), especially those composed of unmodified PET.

In the case that the base interlinings of the invention shall additionally have a flame retardant effect, it is of advantage if they are spun from flame retardant modified polyesters. Such flame retardant modified polyesters are known. They contain additions of halogen compounds, in particular bromine compounds, or, which is particularly advantageous, they contain phosphorous compounds which are contained in the polyester chain as condensed units.

It is particularly preferred that the spunbonded non-wovens contain flame retardant modified polyesters having structural groups of the formula (I)

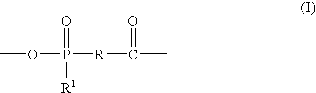

wherein R represents alkylene or polymethylene having 2 to 6 carbon atoms, or phenyl, and R¹ represents alkyl having 1 to 6 carbon atoms, aryl or aralkyl, which are contained in the chain as condensed units. In this formula (I), R preferably represents ethylene, and R¹ preferably represents methyl, ethyl, phenyl or o-, m- or p-methyl-phenyl, in particular methyl. Such spunbonded non-wovens are described in DE-A-39 40 713, for example.

The polyesters contained in the spunbonded non-wovens preferably have a molecular weight corresponding to an intrinsic viscosity (IV) of 0.6 to 1.4, measured in a solution of 1 g polymer in 100 ml dichloroacetic acid at 25 DEG C.

The filament titer of the polyester filaments in spunbonded non-wovens is between 1 and 16 dtex, preferably 2 to 8 dtex.

In another embodiment of the present invention, the textile surface or the spunbonded non-woven can also be a non-woven fabric which has been consolidated by means of a melt binder, said non-woven fabric containing substrate fibers and melt bonding fibers. Said substrate fibers and melt bonding fibers can be derived from any thermoplastic filament-forming polymers. Beyond that, substrate fibers can be derived from non-fusing filament-forming polymers. Such spunbonded non-wovens which have been consolidated by means of a melt binder are described, for example, in EP-A-0,446,822 and EP-A-0,590,629.

Examples of polymers from which the substrate fibers can be derived are polyacrylonitrile, polyolefins, such as polyethylene or polypropylene, essentially aliphatic polyamides, such as nylon 6.6, essentially aromatic polyamides (aramids), such as poly-(p-phenylene terephthalate) or copolymers containing a proportion of aromatic m-diamine units to improve the solubility, or poly-(m-phenylene isophthalate), essentially aromatic polyesters, such as poly-(p-hydroxybenzoate) or preferably essentially aliphatic polyesters, such as polyethylene terephthalate.

The relative proportion of the two fiber types can be selected within wide limits, making sure that the proportion of the melt bonding fibers is selected sufficiently high to ensure that the non-woven fabric reaches a strength sufficient for the desired application by bonding the substrate fibers to the melt bonding fibers. The proportion of the hot-melt adhesive in the non-woven fabric originating from the melt bonding fibers is usually less than 50% by weight, relative to the weight of the non-woven fabric.

Modified polyesters having a melting point which, compared to the raw non-woven fabric, is reduced by 10 to 50 DEG C, preferably by 30 to 50 DEG C, are particularly suitable as hot melt adhesive. Examples of such a hot melt adhesive are polypropylene, polybutylene terephthalate, or polyethylene terephthalate modified by the condensation of longer-chain diols and/or isophthalic acid or aliphatic dicarboxylic acids.

The hot melt adhesives are preferably incorporated into the non-woven fabrics in fibrous form.

The substrate fibers and melt bonding fibers are preferably made up of one class of polymers. This means that all fibers used are selected from one class of substances so that they can be recycled without any problems after the non-woven fabric has been used. If the substrate fibers are composed of polyester, for example, the melt bonding fibers will likewise be of polyester or a mixture of polyesters, for example as a bi-component fiber with PET in the core and a polyethylene terephthalate copolymer having a lower melting point as an envelope. In addition, however, bi-component fibers which are made up of different polymers are also possible. Examples thereof are bi-component fibers of polyester and polyamide (core/envelope).

The monofilament titer of the substrate fibers and melt bonding fibers can be selected within wide limits. Examples of common titer ranges are 1 to 16 dtex, preferably 2 to 6 dtex.

If the base interlinings of this invention having flame retardant properties are additionally bonded, they preferably include flame retardant hot melt adhesives. The laminated sheet of the invention may include, for example, a polyethylene terephthalate modified by incorporation of chain members of the above-indicated formula (I) as a flame retardant hot melt adhesive.

In a preferred embodiment of the invention, the textile fabric has been subjected to a mechanical and/or chemical consolidation. Such a consolidation improves the application properties of the base interlining.

The consolidation may be carried out as individual steps or in combination, wherein care has to be taken, in particular in the presence of reinforcements, to ensure that a possibly present reinforcement will not be damaged or only slightly be damaged. The consolidation is carried out by means of known methods. Possible suitable methods include, without being limited to, mechanical methods, such as needling, in particular hydrodynamic consolidation, as well as chemical and/or thermoplastic methods.

If the consolidation is done mechanically by needling, it is carried out with stitch densities of 20 to 100 stitches/cm², preferably at 40 stitches/cm².

The hydrodynamic consolidation is preferably a water jet needling technique. The pressure applied during the water jet needling process is preferably between 5 and 600 bar, in particular between 50 and 450 bar, most preferably between 100 and 300 bar.

The nozzle diameter is between 0.05 and 0.25 mm, preferably between 0.07 and 0.2 mm. The nozzles are arranged in the form of so-called beams. The number of nozzles is between 10 and 60 nozzles per inch, preferably between 20 and 40 nozzles per inch.

Instead of water, other liquid media can also be used, and the water jet needling process can be carried out in several individual steps. The water jet needling process can be executed by means of a continuous water jet or by means of a pulsed water jet, wherein the pulse frequency is not subject to special restrictions. The water jet needling technique is particularly preferred in the presence of reinforcements.

If the textile fabrics do not contain binding fibers capable of thermal consolidation or only a few binding fibers capable of thermal consolidation, said textile fabrics are impregnated or additionally impregnated with a binder, preferably with one or more chemical binders. Chemical binders on the basis of acrylates or styrenes are particularly suitable for this purpose. Besides the chemical binders, also binders on the basis of starches can be used. The binder content is advantageously up to 30% by weight, preferably 2 to 25% by weight. The precise choice of binder is made according to the specific requirements of the subsequent processor. Hard binders permit high processing speeds during impregnation, especially bituminization, whereas a soft binder provides particularly high values of tear and nail pullout resistance.

In a further embodiment, also flame-retardant modified binders can be used.

The filaments or staple fibers from which the non-woven fabrics are prepared may have a virtually round cross section or have other forms, such as dumbbell-like, kidney-like, triangular or tri- or multilobal cross sections. It is also possible to use hollow fibers and bicomponent or multicomponent fibers. Furthermore, the melt binding fiber can also be used in the form of bicomponent or multicomponent fibers.

The textile fabric may have a single-layer or multilayer structure.

The fibers constituting the textile fabric may be modified by customary additives, for example by antistatics, such as carbon black.

The weight per unit area of the textile fabric, in particular of the spunbonded non-woven, is between 20 and 500 g/m², preferably 40 and 400 g/m², in particular 120 and 300 g/m². In the case that binders are used, the aforementioned weight per unit areas refer to fabrics with binders.

The textile fabric present in the base interlining of the invention has been subjected to a special calendering process.

By means of the calendering technique, the textile fabric is consolidated. If the density before calendering is in the range of about 0.1 to 0.2 g/cm³, the density of the textile fabric after calendering is preferably at least 0.22 g/cm³, in particular at least 0.25 g/cm³, most preferably at least 0.3 g/cm³. The density is preferably increased by at least 50%, most preferably by at least 70%. The above specifications refer to textile fabrics on the basis of polyesters and have to be adjusted according to the density ratio of polyester versus another material if textile fabrics composed of other materials are used. These variations are accessible to persons skilled in the art without inventive effort, and are encompassed by the present invention.

The thickness of the textile fabric reduces by the calendering process preferably by at least 30%, particularly by at least 40%, most preferably by at least 45%. If the thickness before calendering is in the range of about 1 to 2 mm, the thickness of the textile fabric after calendering is preferably less than 1 mm, particularly less than 0.8 mm, most preferably 0.75 mm and less. The above specifications refer to textile fabrics on the basis of polyesters and have to be adjusted accordingly if textile fabrics composed of other materials are used. These variations are accessible to persons skilled in the art without inventive effort, and are encompassed by the present invention.

By means of the compressive calendering technique, the air permeability is adjusted to a value between 250 and 1000 l/m² sec (measured in conformity with EN-ISO 9237), preferably between 300 and 900 l/m² sec, particularly between 350 and 750 l/m² sec, so that the textile fabric permits a reduced uptake of impregnating compound or impregnating bitumen during the subsequent coating process or bituminization of the base interlining of the invention. Also when using other coating compounds for coating, it can be noted that pre-saturation can be omitted, at least partially. The use of the base interlining of the invention results in a reduction of the production costs and the materials used.

The calendaring process is preferably carried out at a linear load of 100 to 150 daN/cm, particularly 125 to 140 daN/cm. The surface temperature of the calendar-rolls is preferably between 180 and 260 DEG C, particularly between 225 and 250 DEG C. The above specifications refer to textile fabrics on the basis of polyesters and have to be adjusted accordingly if textile fabrics composed of other materials are used. These variations are accessible to persons skilled in the art without inventive effort, and are encompassed by the present invention.

Calendering, in particular calendering by means of S-calendering, that is, by means of an enlacement in S-shape, additionally increases the thermal dimensional stability of the textile fabric. In the longitudinal direction, an improvement of the dimensional stability of at least 20% (related to the dimensional stability before calendering), preferably of at least 25% is determined, and in the transverse direction, an improvement of the dimensional stability of at least 30% (related to the dimensional stability before calendering), preferably of at least 35% is determined. TDS is measured in conformity with DIN 18192.

In a preferred embodiment, no additional tensile forces other than those common to S-calendering processes are applied during the aforementioned calendering process.

In a preferred embodiment of the invention, the thermal dimensional stability of the textile fabric is up to max. 0.9% in the longitudinal direction and up to max. 0.75% in the transverse direction, preferably 0.3 to 0.5%. TDS is measured in conformity with DIN 18192.

In another preferred embodiment of the invention, the textile fabric, after having been calendared, is coated or impregnated with a binder, preferably with one or more chemical binders, and then consolidated. The binder content is between 10 and 25% in weight [related to the overall weight of the textile fabric]. Furthermore, it is of advantage to use a binder, in particular a chemical binder or binder system, which is compatible to coatings applied at a later time. The binders can naturally contain fillers.

The use of highly compressed textile fabrics enables a sensible reduction of impregnating compound, in particular impregnating bitumen.

Moreover, thanks to the smaller thickness of the textile fabric and the smaller thickness of the base interlining resulting thereof, considerably higher roll lengths of coated base interlinings can be reached. By means of the present invention, the overall thickness of the coated sheet can be reduced by at least 10%, so that considerably longer sheets are possible without changing the roll thickness. This leads to a reduction of the transportation costs and an improved handling during processing.

### Further Textile Fabrics

The base interlining of the invention may comprise further textile fabrics besides the textile fabrics already described. These further textile fabrics are preferably different from the textile fabrics mentioned first, that is, they are made of another material or have other textures.

If the textile fabric is made up of synthetic polymers, it may be necessary to install further textile fabrics in the base interlining of the invention in order to optimize the application properties.

Besides the additional textile fabrics mentioned above, the base interlining of the invention may be equipped with further functional layers. This means steps or functional layers which increase the resistance to penetration of roots of the base interlining, for example. Said steps and functional layers are also the subject-matter of the invention.

The production of the base interlining of the invention comprises the following steps:
a) generation of a textile fabric and consolidation thereof;
b) calendering of the textile fabric and increasing the density of the textile fabric by at least 50%;
c) applying a binder and consolidation of the binder.

The generation of the textile fabric is carried out by means of known measures. Preferably, the generation of a textile fabric described under a) is done by producing a spunbonded non-woven by means of spinning apparatus known per se.

For this purpose, the molten polymer is supplied with polymers by several series-connected rows of spinning nozzles or groups of spinning nozzle rows. If a spunbonded non-woven consolidated by means of a melt binder shall be produced, feeding is alternately done with polymers which constitute the substrate fibers and the melt bonding fibers. The freshly spun polymer flows are stretched in a manner known per se and deposited in a dispersed texture on a conveyor belt, for example using a rotating deflecting plate.

The consolidation is also carried out by means of known methods.

The installation of the possibly present reinforcement is done during or after the generation of the textile fabric. If the reinforcement shall absorb the applied forces already at low elongations of the base interlining, the installation of the reinforcement is done after the calendering process of step b) or after step c).

The feeding of a further textile fabric which is possibly to install is done after the calendering process of step b) or after step c). In this context, it is of advantage to install the reinforcement which is possibly to install together with the further textile fabric or previous to it. In the latter case, the reinforcement is sandwiched between the two textile fabrics. The feeding of the reinforcement and any thermal treatment during the production process of the base interlining is preferably carried out under tension, in particular under longitudinal tension.

The calendering process of step b) is preferably carried out at a linear load of 100 to 150 daN/cm, in particular 125 to 140 daN/cm. The surface temperature of the calendar-rolls is preferably between 180 and 260 DEG C, in particular between 225 and 250 DEG C. The above specifications refer to textile surfaces on the basis of polyesters and have to be adjusted accordingly to if textile fabrics composed of other materials are used. These variations are accessible to persons skilled in the art without inventive effort, and are encompassed by the present invention.

The calendering process of the textile fabric of step b) causes a consolidation. If the density before calendering is in the range of about 0.1 to 0.2 g/cm³, the density of the textile fabric after calendering is preferably at least 0.22 g/cm³, particularly at least 0.25 g/cm³, most preferably at least 0.3 g/cm³. It is particularly preferred that the density is increased by at least 70%. The above specifications refer to textile surfaces on the basis of polyesters and have to be adjusted according to the density ratio of polyester versus another material if textile fabrics composed of other materials are used. These variations are accessible to persons skilled in the art without inventive effort, and are encompassed by the present invention.

The thickness of the textile fabric decreases by calendering preferably by at least 30%, particularly by at least 40%, most preferably by at least 45%, and reduces to the thicknesses stated at the beginning.

The calendering process is preferably carried out by means of an S-calendering technique, that is, by means of an enlacement of the textile fabric in S-shape. It causes an improvement of the dimensional stability of the textile fabric. In the longitudinal direction, an improvement of the dimensional stability of at least 20% (related to the dimensional stability before calendering), preferably of at least 25% is determined, and in the transverse direction, an improvement of the dimensional stability of at least 30% (related to the dimensional stability before calendering), preferably of at least 35% is determined.

In a preferred embodiment, no additional tensile forces other than those common to S-calendering processes are applied during the aforementioned calendering process.

The application process of the binder according to step c) is also carried out by means of known methods. The applied layer of binder is between 10 and 25% per weight. The used binder is preferably compatible with the coating applied by the customer.

Drying and solidification of the binder are also executed by means of methods known to persons skilled in the art.

The individual procedure steps on their own are known. In the combination and order of the invention, however, they are patentable.

The base interlining of the invention can be used to produce coated sarking membranes, roofing membranes and sealing membranes, preferably to produce bituminized sarking membranes, roofing membranes and sealing membranes.

The latter are also the subject-matter of the present invention. During the production, the carrier material is treated in a manner known per se with the compound used for coating, in particular bitumen, and subsequently strewed with a granular material, for example with sand, if required. The sarking membranes, roofing membranes and sealing membranes thus produced distinguish themselves by good processability.

Besides bitumen, also other materials, such as polyethylene or polyvinyl chloride, polyurethane, EPDM or TPO (polyolefins) are used as coating compounds for the coated sarking membranes, roofing membranes and sealing membranes.

The bituminized sheets contain at least one support sheet or base interlining as described above which is embedded in a bitumen matrix, wherein the weight proportion of the bitumen related to the weight per unit area of the bituminized roofing membrane is preferably 60 to 97% by weight and that of the spunbonded non-wovens is 3 to 40% by weight. Due to the small thickness of the base interlining, the overall thickness is reduced by at least 10% with the same layer of coating compound. The advantages resulting thereof have already been described at the beginning. With a base interlining of the invention (on the basis of polyester) having an weight per unit area of about 180 g/m², the proportion of required impregnating bitumen reduces from about 550 g/m² to about 300 g/m².

### Example

A spunbonded non-woven on the basis of polyethylene terephthalate (PET) is produced and consolidated by needling. The weight per unit area is 180 g/m². Subsequently, a calendering (S calendering) process is carried out at 225 DEG C and a linear load of 135 daN/cm, resulting in a reduction of the thickness of the non-woven fabric from 1.25 mm to 0.7 mm.

The thermal dimensional stability (TDS) improves from −1.15% to −0.85% (in longitudinal direction; MD) and from −0.9% to −0.5% (in transverse direction, CD), corresponding to an improvement by >25% and by >40%, respectively. The TDS is measured in conformity with DIN 18192.

The air permeability of the lining produced according to the invention reduced from 1275 l/m² sec to 544 l/m² sec (measured in conformity with EN-ISO 9237) and is determined as the average value of 10 measurement points.

The following table 1 shows die air permeability of the interlining produced according to the invention before and after calendering.

TABLE 1

| | Permeability | Permeability |
|---|---|---|
| Measurement | [l/m² sec] | [l/m2 sec] |
| 1 | 1200 | 700 |
| 2 | 1250 | 650 |
| 3 | 1350 | 550 |
| 4 | 1300 | 500 |
| 5 | 1250 | 550 |
| 6 | 1300 | 500 |
| 7 | 1300 | 400 |
| 8 | 1250 | 390 |
| 9 | 1300 | 550 |
| 10 | 1250 | 650 |
| Average value | 1275 | 544 |
| max | 1350 | 700 |
| min | 1200 | 390 |

Table 2 shows the influence of the calendering process on the thickness and the density of the base interlining of the invention.

TABLE 2

| Areal | | | | | Δ | Δ | Δ | Δ |
|---|---|---|---|---|---|---|---|---|
| weight | Thickness | Density | Thickness 1 | Density 1 | Thickness | Thickness | Density | Density |
| [g/m²] | [mm] | [g/cm³] | [mm] | [g/cm³] | [mm] | [%] | [g/cm³] | [%] |
| 180 | 1.25 | 0.144 | 0.7 | 0.257 | −0.550 | −44.0% | 0.113 | 78.6 |
| 140 | 1 | 0.140 | 0.55 | 0.255 | −0.450 | −45.0% | 0.115 | 81.3 |
| 200 | 1.3 | 0.154 | 0.75 | 0.267 | −0.550 | −42.3% | 0.113 | 73.3 |
| 300 | 1.8 | 0.167 | 1 | 0.300 | −0.800 | −44.4% | 0.133 | 80.0 |

wherein:
thickness is the thickness before calendering; thickness 1 is the thickness after calendering;
density is the density before calendering; density 1 is the density after calendering.

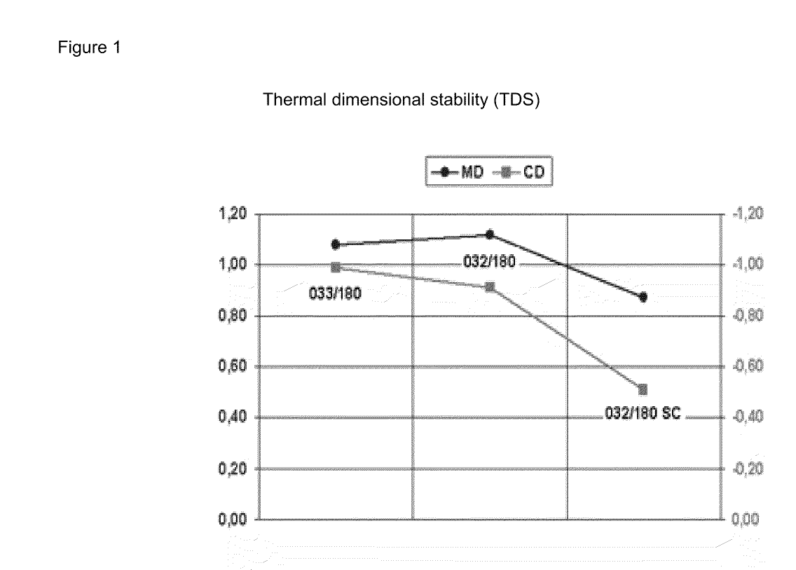

FIG. 1 represents the improvement of the TDS of the base interlining of the invention (032/180 SC) compared with base interlinings without the calendering process of the invention (033/180) and (032/180). The abbreviation MD means Main Direction (longitudinal direction); the associated values [%] can be obtained from the labels of the left axis, wherein the upper curve (circular symbols) has to be considered. The abbreviation CD means Cross Direction (transverse direction); the associated values can be obtained form the labels of the right axis, wherein the lower curve (square symbols) has to be considered.

While various embodiments have been described, it is to be understood that variations and modifications may be resorted to as will be apparent to those skilled in the art. Such variations and modifications are to be considered within the purview and scope of the claims appended hereto.

1. A base interlining comprising a textile fabric, wherein the textile fabric has:
a) a weight per unit area of between 20 to 500 g/m²;
b) an air permeability of between 250 and 1000 l/m² sec, measured according to EN-ISO 9237;
c) a thermal dimensional stability of up to 0.9% in a longitudinal direction and up to 0.75% in a transverse direction, measured according to DIN 18192;
d) a maximum tensile force lengthwise/crosswise of >500/>300 N/5 cm, measured according to DIN 29073, part 3; and
e) a perforation resistance of >1200 N, measured according to DIN 54 307.

2. The base interlining according to claim 1, wherein the textile fabric comprises one or more additional reinforcements.

3. The base interlining according to claim 1, wherein said base interlining comprises at least one further textile fabric that is different from the textile fabric.

4. The base interlining according to claim 1, wherein said base interlining consists of the textile fabric.

5. The base interlining according to claim 2, wherein said base interlining consists of the textile fabric.

6. The base interlining according to claim 1, wherein said base interlining has an elongation reserve of less than 1%.

7. The base interlining according to claim 1, wherein the textile fabric is a non-woven fabric composed of fibers of synthetic polymers.

8. The base interlining according to claim 7, wherein the textile fabric is a non-woven fabric comprising polyester fibers.

9. The base interlining according to claim 8, wherein the polyester fibers comprise staple fibers or continuous fibers.

10. The base interlining according to claim 1, wherein the textile fabric has a density of at least 0.22 g/cm³.

11. The base interlining according to claim 1, wherein the textile fabric has a density of at least 0.3 g/cm³.

12. The base interlining according to claim 1, wherein the air permeability of the textile fabric is between 300 and 900 l/m² sec.

13. The base interlining according to claim 1, wherein the air permeability of the textile fabric is between 350 and 750 l/m² sec.

14. A method for producing a base interlining according to claim 1, comprising the following steps:
a) generating a textile fabric and consolidating the textile fabric;
b) calendering the textile fabric and increasing a density of the textile fabric by at least 50%; and
c) applying a binder and consolidating the binder.

15. The method according to claim 14, wherein the calendering is carried out with a linear load of 100 to 150 daN/cm.

16. The method according to claim 14, wherein the calendering comprises using calendar-rolls, a surface temperature of which is between 180 and 260° C.

17. The method according to claim 14, wherein the calendering comprises using calendar-rolls, a surface temperature of which is between 225 and 250° C.

18. The method according to claim 14, wherein:
the calendering causes a consolidation; and
the density of the textile fabric after calendering is at least 0.22 g/cm³.

19. The method according to claim 14, wherein the calendering causes a consolidation of at least 70%.

20. The method according to claim 14, wherein the calendaring reduces a thickness of the textile fabric by at least 30%.

21. The method according to claim 14, wherein the calendering comprises an S-calendering technique comprising an enlacement of the textile fabric in S-shape.

22. The method according to claim 14, wherein the calendering causes an improvement of the dimensional stability of the textile fabric.

23. The method according to claim 14, wherein no additional tensile forces are applied during the calendering.

24. The method according to claim 14, wherein by means of the calendering, the air permeability of the textile fabric is adjusted to a value between 250 and 1000 l/m² sec, measured according to EN-ISO 9237.

25. The method according to claim 14, wherein by means of the calendering, the air permeability of the textile fabric is adjusted to a value between 300 and 900 l/m² sec, measured according to with EN-ISO 9237.

26. A method for producing coated sheets, comprising using at least one base interlining according to claim 1.

27. The method according to claim 26, wherein the coated sheets comprise bituminized roofing membranes.

28. A coated sheet, including at least one base interlining according to claim 1.

29. A bituminized roofing membrane, including at least one base interlining according to claim 1.

30. The bituminized roofing membrane according to claim 29, wherein a weight proportion of bitumen related to a weight per unit area of the bituminized roofing membrane is 60 to 97% by weight, and a weight proportion of the base interlining is 3 to 40% by weight.

31. A base interlining comprising a textile fabric, wherein the textile fabric:
a) has a weight per unit area of between 20 to 500 g/m² and a density of at least 0.22 g/cm³, said textile fabric being a non-woven fabric comprising polyester fibers;
b) has a air permeability of between 250 and 1000 l/m² sec, measured according to EN-ISO 9237;
c) has a thermal dimensional stability of up to 0.9% in a longitudinal direction and up to 0.75% in a transverse direction, measured according to DIN 18192;
d) has a maximum tensile force of lengthwise/crosswise is >500/>300 N/5 cm, measured according to DIN 29073, part 3;
e) has a perforation resistance of >1200 N, measured according to DIN 54 307.

32. A method for producing a base interlining according to claim 1, comprising the following steps:
a) generating a textile fabric and consolidating the textile fabric;
b) calendering the textile fabric and increasing a density of the textile fabric by at least 50%, said calendering comprising an S-calendering technique comprising an enlacement of the textile fabric in S-shape, said calendering being carried out such that no additional tensile forces are applied during said calendering; and
c) applying a binder and consolidating the binder.

33. A method for producing a base interlining according to claim 1, comprising the following steps:
a) generating a textile fabric and consolidating the textile fabric, said textile fabric being a non-woven fabric composed of fibers of synthetic polymers;
b) calendering the textile fabric and increasing a density of the textile fabric by at least 50%, said calendering being comprising an S-calendering technique comprising an enlacement of the textile fabric in S-shape, said calendering being carried out such that no additional tensile forces are applied during said calendering, said calendering being carried out with a linear load of 100 to 150 daN/cm, wherein the calendering comprises using calendar-rolls, a surface temperature of which is between 180 and 260° C.; and
c) applying a binder and consolidating the binder.
